(19) United States
(12) Patent Application Publication
(10) Pub. No.: US 2007/0263307 A1
(43) Pub. Date: Nov. 15, 2007

(54) LIGHT INTEGRATION ROD MODULE AND OPTICAL ENGINE

(75) Inventors: Li-Han Wu, Hsinchu (TW); Wan-Chiang Wang, Hsinchu (TW); Chi-Chui Yun, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/735,878

(22) Filed: Apr. 16, 2007

(30) Foreign Application Priority Data
May 11, 2006 (TW) 95116722

(51) Int. Cl. G02B 5/00

(52) U.S. Cl. 359/894

(57) ABSTRACT

A light integration rod module includes a holder, a light integration rod disposed in an accommodation space of the holder, a bracket set supporting the holder and the light integration rod, and an adjusting unit adjusting the relative positions of the holder and the bracket set and including a first adjusting element, a second adjusting element and an elastic element. The first and second adjusting elements are disposed through the bracket set and pushing the holder to adjust the relative positions of the holder and the bracket set along a first and a second axis directions respectively. Both ends of the elastic element are respectively connected to the bracket set and the holder and providing the holder with a pull force towards the bracket set. The direction of the pull force is different from the first and second axis directions.

### CROSS-REFERENCE TO RELATED APPLICATION

This application claims the priority benefit of Taiwan application serial no. 95116722, filed May 11, 2006. All disclosure of the Taiwan application is incorporated herein by reference.

### BACKGROUND OF THE INVENTION

1. Field of Invention

The present invention relates to an optical component used in an optical projection apparatus, and more particularly to a light integration rod module and an optical engine.

2. Description of the Related Art

An optical projection apparatus includes an optical engine and a projection lens module. The optical engine used is for providing an image, while the projection lens module is projecting the image onto a screen. Referring to FIGS. 1A-1C, a conventional optical engine 10 includes a light source 11, a light integration rod module 100, a light valve 12 and a case 13. The light source 11 is suitable for producing a light beam, and the light integration rod module 100 is suitable for homogenizing the light beam, and the light valve 12 is suitable for converting the light beam into an image. The light integration rod module 100 and the light valve 12 are disposed in the case 13. The homogeneous extent of the light beam depends on the position where the light beam gets incident into the light integration rod in the light integration rod module 100. Therefore, for a more homogeneous result, the light integration rod module 100 is usually equipped with an adjusting unit for adjusting the position of the light integration rod.

Referring to FIGS. 2A˜2C, a conventional light integration rod module 100 includes a holder 110, a light integration rod 120, a bracket set 130, an adjusting unit 140 and an auxiliary adjusting unit 150. An accommodation space S is formed on the holder 110 for accommodating the light integration rod 120.

The bracket set 130 is used for supporting the holder 110 and the light integration rod 120, and includes a first bracket 132 and a second bracket 134. The first bracket 132 is connected to the second bracket 134 by a first positioning screw 136 for restricting on the relative movement of the first bracket 132 and the second bracket 134 along a direction of the Y axis, while the second bracket 134 is connected to the holder 110 by a second positioning screw 138 for restricting along the relative movement of the second bracket 134 and the holder 110 along a direction of the X axis.

The adjusting unit 140 includes a first adjusting screw 141, a first spring 142, a second adjusting screw 143 and a second spring 144, and is used for adjusting the relative positions of the holder 110 and the bracket set 130 along the direction of the X axis and along the direction of the Y axis. The auxiliary adjusting unit 150 includes a first auxiliary screw 151, a fifth spring 152, a second auxiliary screw 153 and a sixth spring 154, and is used for avoiding a rotation of the holder 110 and the bracket set 130 and a displacement of the holder 110 and the bracket set 130 but the relative displacement along the direction of the X axis and the direction of the Y axis. In addition, since the light beam gets incident into the light integration rod 120 along a direction of the axis Z, adjusting the relative position between the holder 110 and the bracket set 130 results in an adjusted new position where the light beam gets incident into the light integration rod 120.

The adjusting unit 140 further includes a third spring 145 and a fourth spring 146 for respectively tolerating the gap error between the first adjusting screw 141 and the first bracket 132 and the gap error between the second adjusting screw 143 and the second bracket 134.

To fully adjust the relative position of the holder 110 and the bracket set 130 in the light integration rod module 100, six screws and six springs in total are required. Therefore, such a conventional structure requires too many components for assembling the module, which leads to an expensive cost and a lot of working hours to complete an assembly with so many components. Besides, the complexity of the sheet metal structures of the holder 110 and the bracket set 130 is an important barrier to lower the fabrication cost of the holder 110 and the bracket set 130.

During a course for the light integration rod module 100 to homogenize a light beam, a part of the light beam energy is absorbed by the light integration rod module 100 and then converted into heat, which is hard to be dissipated into the ambient. The heat accumulated inside the case 13 causes the optical engine 10 overheated to reduce the image quality, moreover to make the light integration rod 120 deformed seriously and to damage the optical engine 10.

### SUMMARY OF THE INVENTION

A first objective of the present invention is to provide a light integration rod module for lowering the production cost and the working hours for assembling.

A second objective of the present invention is to provide an optical engine, which includes a light integration rod module with cheaper cost, therefore lowers the fabrication cost of the optical engine.

A third objective of the present invention is to provide an optical engine, which possesses a better heat-dissipation effect.

A fourth objective of the present invention is to provide an optical engine, which possesses stable quality and longer lifetime.

To achieve the above-described one, some or other objectives, the present invention provides a light integration rod module, which is suitable for an optical engine to homogenize a light beam provided by a light source of the optical engine. The light integration rod module includes a holder, a light integration rod, a bracket set and an adjusting unit. The holder forms an accommodation space and the light integration rod is disposed in the accommodation space. The bracket set is suitable for supporting the holder and the light integration rod. The adjusting unit is suitable for adjusting the relative positions of the holder and the bracket set and includes a first adjusting element, a second adjusting element and an elastic element. The first adjusting element is disposed through the bracket set and suitable for pushing the holder to adjust the relative positions of the holder and the bracket set along a first axis direction. The second adjusting element is disposed through the bracket set and suitable for pushing the holder to adjust the relative positions of the holder and the bracket set along a second axis direction. Both ends of the elastic element are respectively connected onto the bracket set and the holder and suitable for providing the holder with a pull force towards the bracket set. The pull force direction is different from both the first axis direction and the second axis direction.

The present invention further provides an optical engine, which includes a light source, an above-described light integration rod module, a light valve and a case. The light source is suitable for providing a light beam, the light integration rod module is disposed on the optical path of the light beam and the light valve is disposed on the optical path of the light beam which passed through the light integration rod module. The light integration rod module and the light valve are disposed inside the case. The light beam gets incident into the light integration rod of the light integration rod module.

The present invention provides an optical engine as well, which includes a light source, a light integration rod module, a light valve and a case. The light source is suitable for providing a light beam, the light integration rod module is disposed on the optical path of the light beam and the light valve is disposed on the optical path of the light beam which passed through the light integration rod module. The light integration rod module and the light valve are disposed inside the case. The light integration rod module includes a holder, a light integration rod, a heat-dissipation fin, a bracket set and an adjusting unit. The holder forms an accommodation space and the light integration rod is disposed in the accommodation space which is available for the light beam to get incident into the light integration rod. The heat-dissipation fin is disposed on the holder or the bracket set, the bracket set is suitable for supporting the holder and the light integration rod, and the heat-dissipation fin is exposed outside the bracket set. In addition, the adjusting unit is suitable for adjusting the relative positions of the holder and the bracket set. In addition, the case has a heat-dissipation portion with a shape matching the heat-dissipation fin, and the heat-dissipation fin is adjacent to the heat-dissipation portion.

In summary, in the light integration rod module and the light engine of the present invention, the adjusting unit only includes a first adjusting element, a second adjusting element and an elastic element to complete adjusting the position where the light beam gets incident into the light integration rod (i.e. the relative positions of the holder and the bracket set). In this way, the component number and the cost are saved in addition to reduce the labor time for assembling. Besides, the heat-dissipation fin is disposed on the holder or the bracket set and exposed outside the case according to the present invention, which is able to effectively remove the heat in the light integration rod and assure the light engine to maintain stable quality during working.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A and 1B are two exploded views of a conventional optical engine with different view angles.

FIG. 1C is a partial cross-sectional view of the optical engine in FIG. 1A after assembling.

FIG. 2A is an exploded view of a conventional light integration rod module.

FIG. 2B is an assembly view of the light integration rod module in FIG. 2A.

FIG. 2C is a side view of the light integration rod module in FIG. 2B.

FIG. 3A is an exploded view of a light integration rod module according to an embodiment of the present invention.

FIG. 3B is an assembly view of the light integration rod module in FIG. 3A.

FIG. 3C is a side view of the light integration rod module in FIG. 3B.

FIG. 3D is a perspective view of a wire spring.

FIG. 3E and FIG. 3F are two schematic views of a light integration rod module according to a second embodiment of the present invention.

FIG. 3G is a schematic drawing of a light integration rod module according to a third embodiment of the present invention.

FIG. 4A and 4B are two exploded views of an optical engine with different view angles according to one embodiment of the present invention.

FIG. 4C is a partial cross-sectional view of the optical engine in FIG. 4A after assembling.

FIG. 5 is a partial cross-sectional view of an optical engine according to another embodiment of the present invention.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

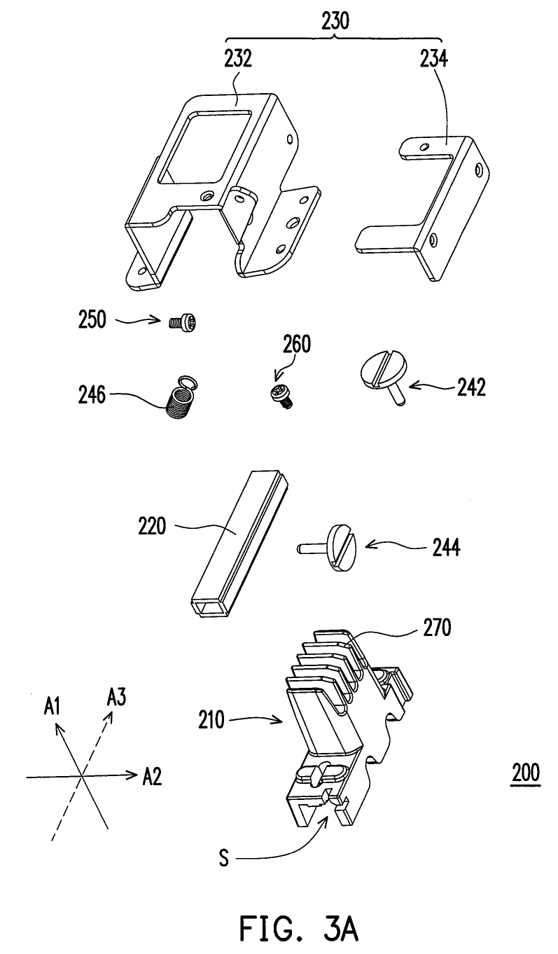

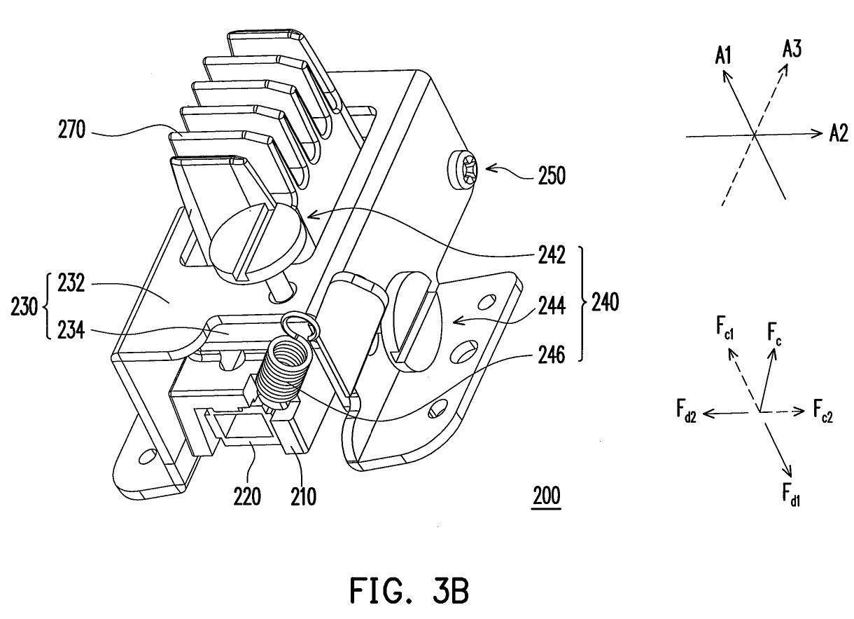

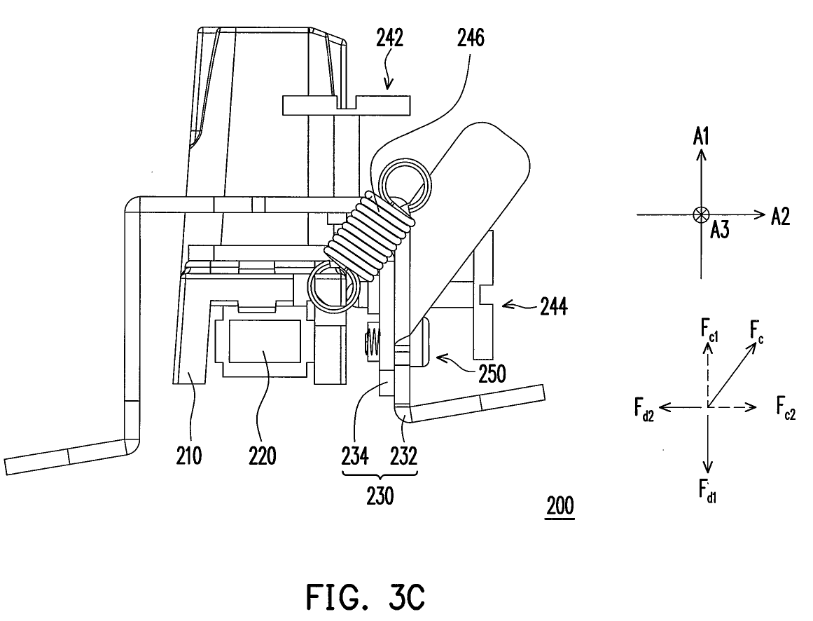

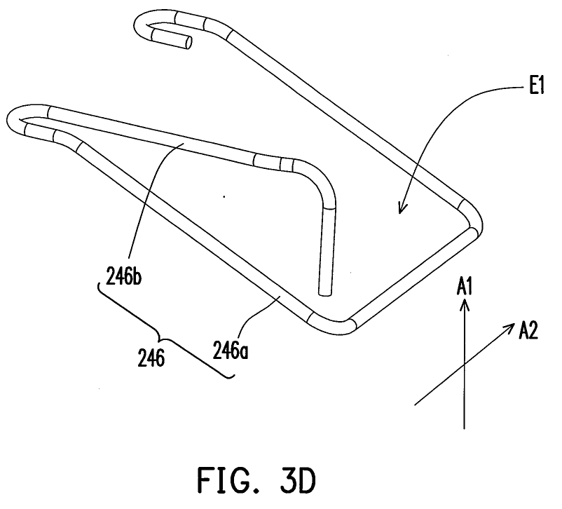

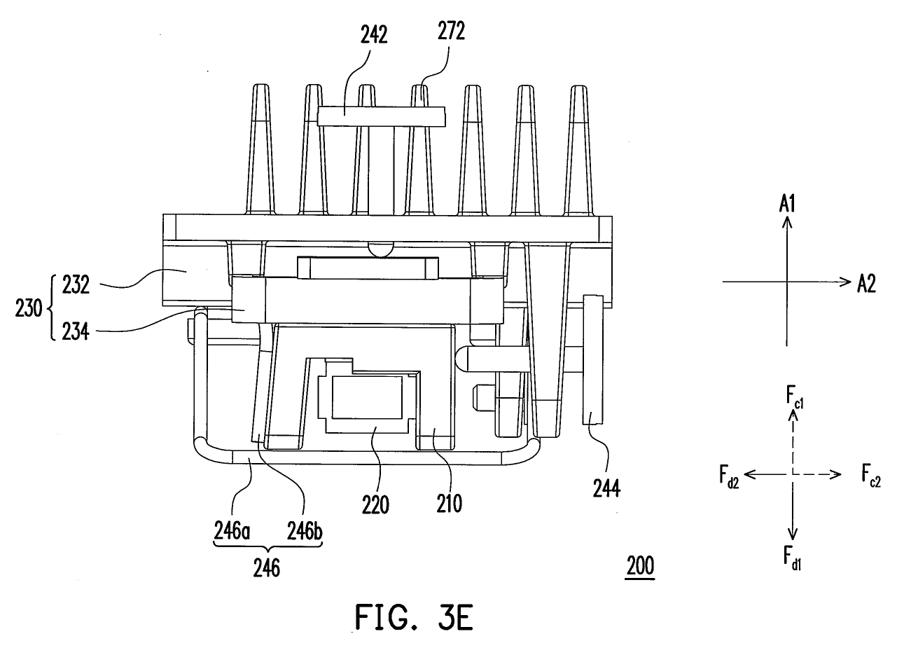

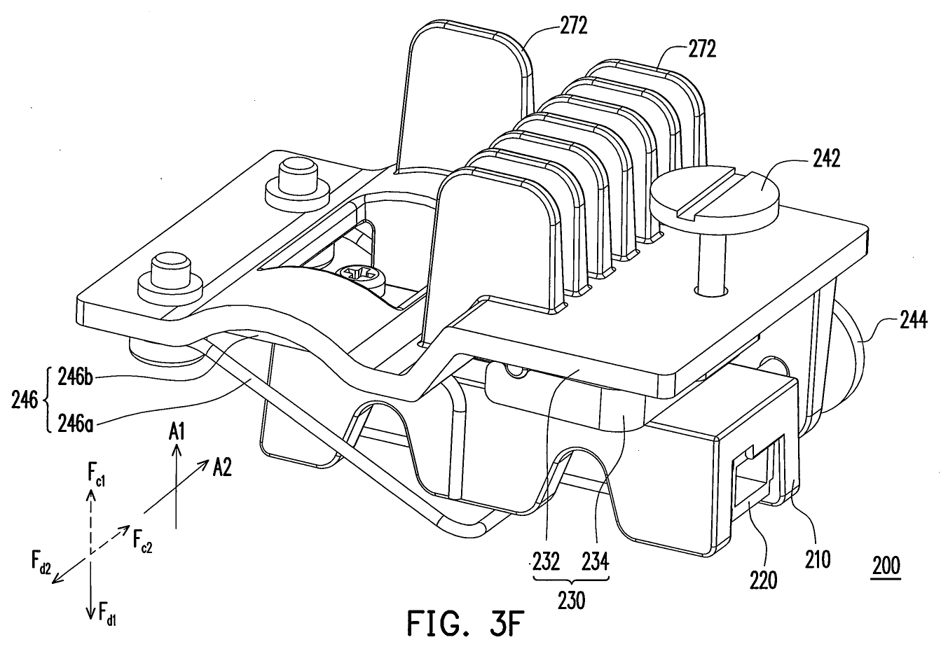

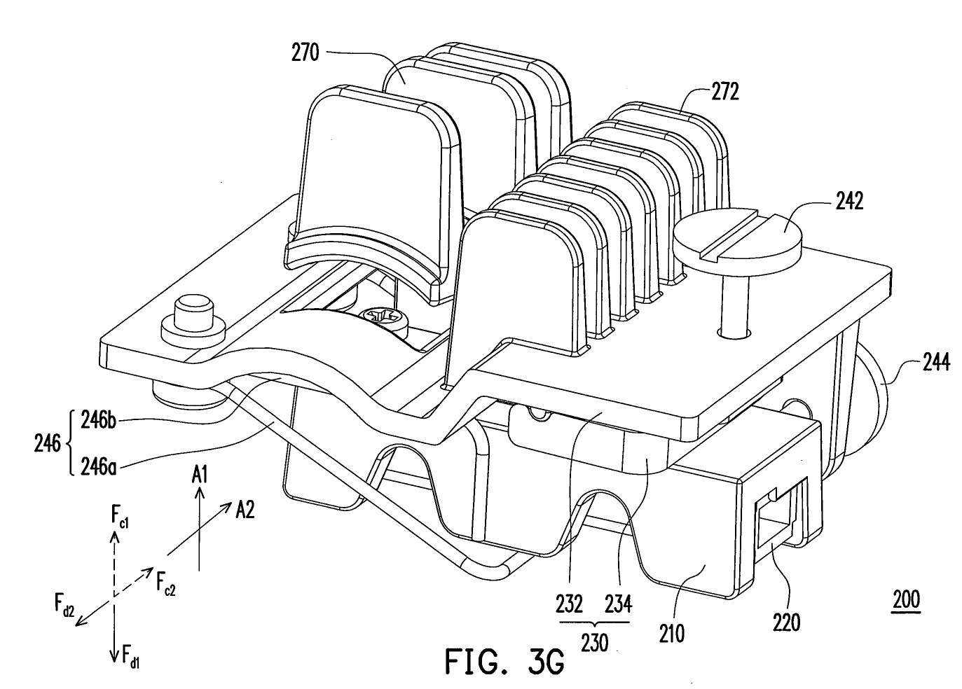

Referring to FIGS. 3A˜3C, a light integration rod module 200 of the present invention includes a holder 210, a light integration rod 220, a bracket set 230 and an adjusting unit 240. The holder 210 forms an accommodation space S and the light integration rod 220 is disposed in the accommodation space S. The bracket set 230 is suitable for supporting the holder 210 and the light integration rod 220.

The adjusting unit 240 is suitable for adjusting the relative positions of the holder 210 and the bracket set 230 and includes a first adjusting element 242, a second adjusting element 244 and an elastic element 246. The first adjusting element 242 is disposed through the bracket set 230 and suitable for pushing the holder 210 to adjust the relative positions of the holder 210 and the bracket set 230 along a first axis direction Al. The second adjusting element 244 is disposed through the bracket set 230 and suitable for pushing the holder 210 to adjust the relative positions of the holder 210 and the bracket set 230 along a second axis direction A2. Both ends of the elastic element 246 are respectively connected onto the bracket set 230 and the holder 210; in more detail, both ends of the elastic element 246 respectively hitch the bracket set 230 and the holder 210. The elastic element 246 is suitable for providing the holder 210 a pull force F_{c} with a direction towards the bracket set 230 and different from both the first axis direction A1 and the second axis direction A2.

Referring to FIGS. 3A˜3C again, in the present embodiment, the light integration rod module 200 further includes a first connection element 250 and a second connection element 260. The bracket set 230 includes a first bracket 232 and a second bracket 234. The first bracket 232 is connected to the second bracket 234 through the first connection element 250, while the second bracket 234 is connected to the holder 210 through the second connection element 260. The first connection element 250 functions as a rotary shaft to restrict on the relative movement of the first bracket 232 and the second bracket 234 along the second axis direction A2, while the second connection element 260 functions as a rotary shaft to restrict on the relative movement of the second bracket 234 and the holder 210 along the first axis direction Al. Besides, both ends of the elastic element 246 hitch the first bracket 232 (outside bracket) and the holder 210, respectively.

In more detail, the first adjusting element 242 is disposed through the first bracket 232 along the first axis direction A1 and one end of the first adjusting element 242 comes into contact with the second bracket 234. Since the second connection element 260 has restricted on the relative movement of the second bracket 234 and the holder 210 along the first axis direction A1 already, thus, adjusting the first adjusting element 242 a first push force F_{d1} is produced which is exerted onto the holder 210 from the first bracket 232 along an opposite direction of the first axis direction A1, that is to say, the direction of the first push force F_{d1} is away from the bracket set 230. As a result, the first push force F_{d1} adjusts the relative positions of the holder 210 and the first bracket 232 (the bracket set 230) along the first axis direction A1.

Similarly, the second adjusting element 244 is disposed through the second bracket 234 along the second axis direction A2 and one end of the second adjusting element 244 comes into contact with the holder 210. Thus, by adjusting the second adjusting element 244 a second push force F_{d2} is produced which is exerted onto the holder 210 from the second bracket 234 along an opposite direction of the second axis direction A2 that is to say, the direction of the second push force F_{d2} is away from the bracket set 230, so that the relative positions of the holder 210 and the second bracket 234 (the bracket set 230) along the second axis direction A2 are adjusted.

Since the direction of the pull force F_{c} exerted by the elastic element 246 onto the holder 210 is different from both the first axis direction A1 and the second axis direction A2, the pull force F_{c} is resolved into a first pull force F_{c1} and a second pull force F_{c2} (in turn, the first pull force F_{c1} and the second pull force F_{c2} compose the pull force F_{c}). The direction of the first pull force F_{c1} is parallel to the first axis direction A1, while the direction of the second pull force F_{c2} is parallel to the second axis direction A2.

The first pull force F_{c1} takes a direction opposite to that of the first push force F_{d1} and the second pull force F_{c2} takes a direction opposite to that of the second push force F_{d2}. Taking no account of friction force, the first pull force F_{c1} is counterbalanced by the first push force F_{d1}, while the second pull force F_{c2} is counterbalanced by the second push force F_{d2}. Therefore a balance state is maintained between the holder 210 and the bracket set 230. Furthermore, the relative positions of the holder 210 and the bracket set 230 along both the first axis direction A1 and the second axis direction A2 are adjusted by adjusting the first adjusting element 242 and the second adjusting element 244 for changing the balance state between the holder 210 and the bracket set 230.

Since the light beam gets incident into the light integration rod 220 along, for example, a third axis direction A3, thus, adjusting the relative position between the holder 210 and the bracket set 230 implies to adjust the position of the light integration rod 220 where the light beam gets incident into the light integration rod 220; thereby, the homogenized effect of the light beam is regulated. In the present embodiment, the third axis direction A3 is perpendicular to both the first axis direction A1 and the second axis direction A2, while the first axis direction A1 is laid out to be perpendicular to the second axis direction A2 to simplify the structure of the light integration rod module 200.

The first adjusting element 242 and the second adjusting element 244 can be implemented by means of adjusting screws, the elastic element 246 can be a pull coil spring, and the first connection element 250 and the second connection element 260 can be positioning screws, for example. The present invention limits neither the kinds of the first adjusting element 242, the second adjusting element 244, the elastic element 246, the first connection element 250 and the second connection element 260, nor whether the first axis direction A1 is perpendicular to the second axis direction A2.

In addition to a spring, the present invention can also utilize other components as the elastic element 246, for example, a wire spring. FIGS. 3D˜3F give the detail explanations hereinafter.

Referring to FIG. 3D, the wire spring has a U-shape portion 246a and an L-shape portion 246b. Both ends of the U-shape portion 246a are hooked up with the first bracket 232, for example, both ends thereof have C-shape structures which are together with fasteners for hooking. Besides, the U-shape portion 246a and the L-shape portion 246b are connected together to form integrally. The connection portion is just at one of the hooking positions of the two ends of the U-shape portion 246a. The L-shape portion 246b lifts up relatively to the U-shape portion 246a. In other words, differently from the U-shape portion 246a which is on a plane E1, the L-shape portion 246b is out of the plane E1.

FIG. 3E and FIG. 3F are two schematic views of a light integration rod module according to a second embodiment of the present invention. Referring to FIGS. 3E and 3F, the U-shape portion 246a of the present embodiment is used for adjusting the relative positions of the first bracket 232 and the holder 210 along the first axis direction A2, while the L-shape portion 246b is for adjusting the relative positions of the first bracket 232 and the holder 210 along the second axis direction A2.

The first adjusting element 242 exerts a first push force F_{d1} onto the holder 210 through the first bracket 232 along the opposite direction of the first axis direction A1, so as to adjust the relative positions of the holder 210 and the first bracket 232 (the bracket set 230) along the first axis direction A1. Since a direction of a first pull force F_{c1} exerted by the U-shape portion 246a of the wire spring onto the holder 210 is along the first axis direction A1, taking no account of friction force, the first pull force F_{c1} is counterbalanced by the first push force F_{d1}. Therefore a balance state is maintained between the holder 210 and the bracket set 230.

Similarly, the second adjusting element 244 exerts a second push force F_{d2} onto the holder 210 through the first bracket 232 along the opposite direction of the second axis direction A2, so as to adjust the relative positions of the holder 210 and the second 234 bracket (the bracket set 230) along the second axis direction A2. Since a direction of a second pull force F_{c2} exerted by the L-shape portion 246b of the wire spring onto the holder 210 is along the second axis direction A2, taking no account of friction force, the second pull force F_{c2} is counterbalanced by the second push force F_{d2}. Therefore, a balance state is maintained between the holder 210 and the bracket set 230.

Although the U-shape portion 246a and the L-shape portion 246b of the wire spring are connected together, however, while adjusting the holder 210, the first pull force F_{c1} along the first axis direction A1 and the second pull force F_{c2} along the second axis direction A2 are independent from each other and without affecting mutually.

Referring to FIGS. 3A˜3C again, in terms of the first axis direction A1, the situation that the first push force F_{d1} and the first pull force F_{c1} exerted respectively by the first adjusting element 242 and the elastic element 246 onto the holder 210 are located at the same side of the holder 210 (the upper side) enables the elastic element 246 to directly tolerate a gap between the first adjusting element 242 and the first bracket 232. Similarly, in terms of the second axis direction A2, the elastic element 246 is able to directly tolerate a gap between the second adjusting element 244 and the second bracket 234 as well. Therefore, the present invention has no need to dispose an additional elastic element 246 to tolerate the gap between the first adjusting element 242 and the first bracket 232 and the gap between the second adjusting element 244 and the second bracket 234.

Note that when adjusting the relative positions of the holder 210 and the bracket set 230, the first pull force F_{c1} and the second pull force F_{c2} of the elastic element 246 come into balance respectively with the first push force F_{d1} and the second push force F_{d2}. Therefore, the present invention does not require extra auxiliary adjusting screws or the elastic element 246 to prevent the holder 210 and the bracket set 230 from having a relative displacement or a rotation not along the first axis direction A1 and the second axis direction A2.

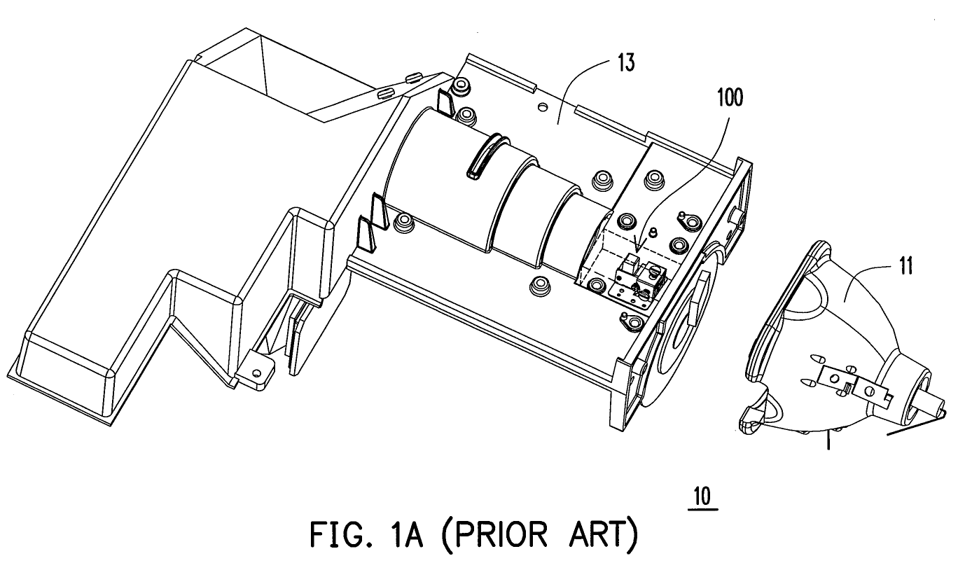

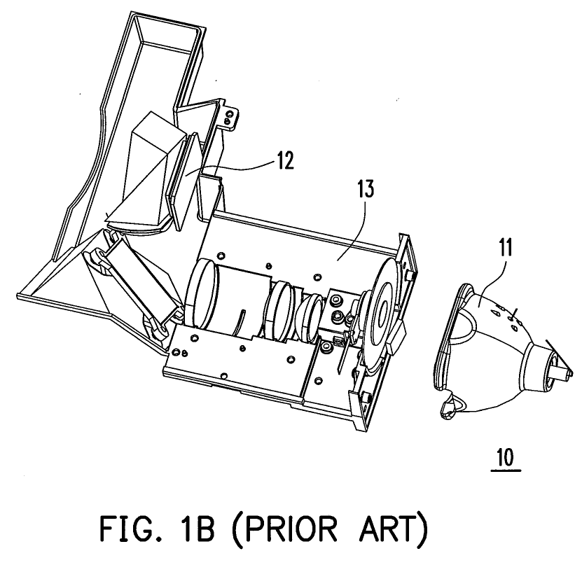

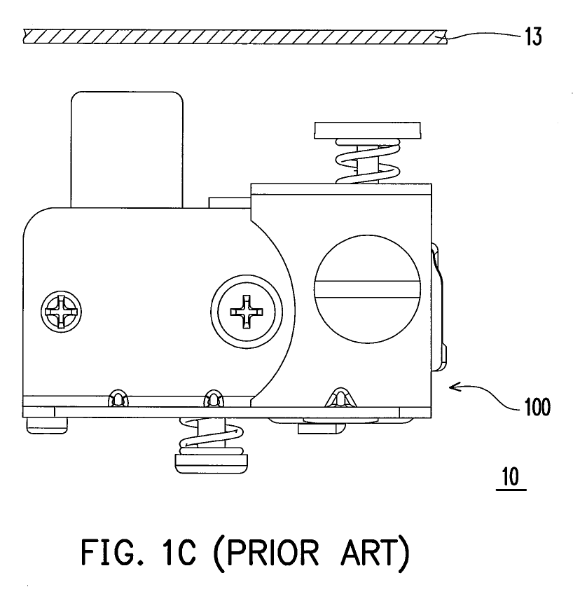

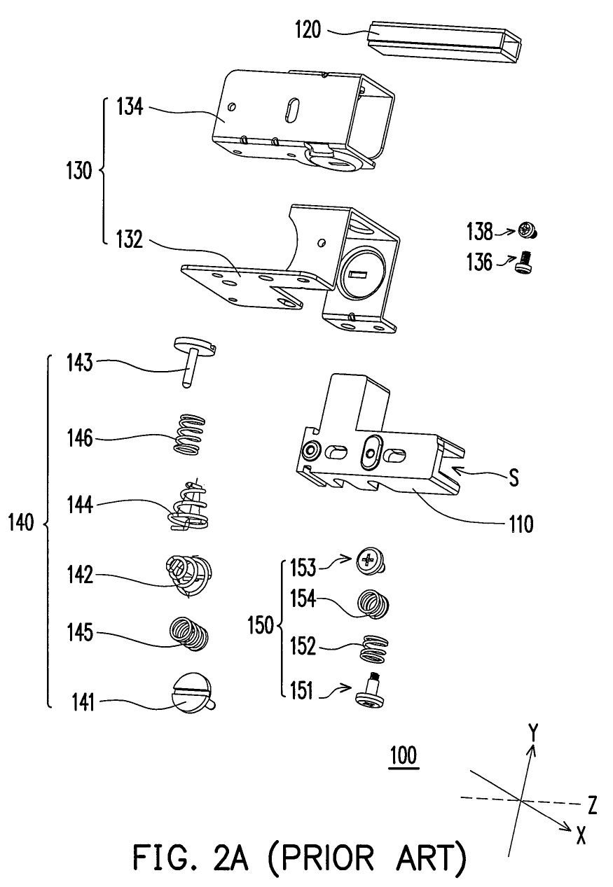

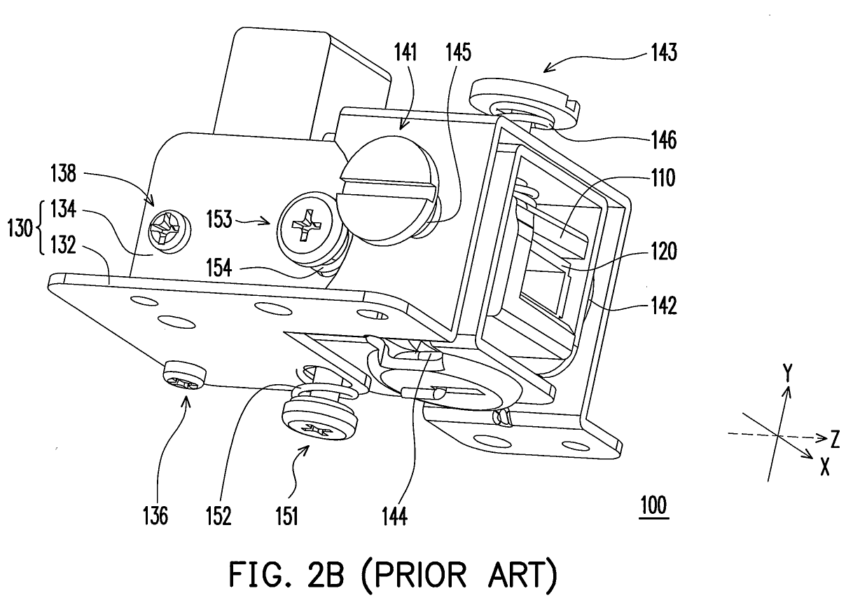

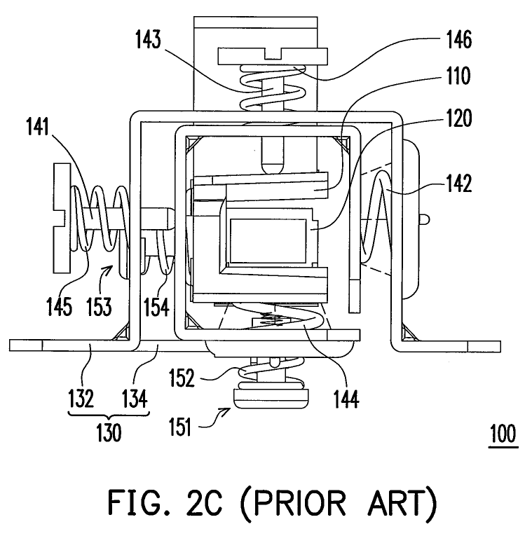

In comparison with the conventional light integration rod module 100 (as shown in FIGS. 1A˜1C), the light integration rod module 200 of the present invention requires four screws (the first adjusting element 242, the second adjusting element 244, the first connection element 250 and the second connection element 260) and a spring (the elastic element 246) only to adjust the relative positions of the holder 210 and the bracket set 230. Therefore, the present invention is able to largely reduce the number of components of the light integration rod module 200 for saving the fabrication cost. Due to a less component number of an assembly, the assembling is accordingly speeded up with a saved working hours. Moreover, due to the simpler structures of the holder 210 and the bracket set 230, the fabrication costs thereof are lowered as well.

Referring to FIGS. 3A˜3C again, to advance the heat-dissipation effect of the light integration rod module 200, the light integration rod module 200 in the first embodiment can further include a heat-dissipation fin 270 disposed on the holder 210 and exposed outside the bracket set 230. In the embodiment, the holder 210 and the heat-dissipation fin 270 can be one-body formed and made of a metal material with high heat-conductivity.

Referring to FIG. 3F, the light integration rod module 200 in the second embodiment further includes another heat-dissipation fin 272 disposed on the first bracket 232. The first bracket 232 and the heat-dissipation fin 272 are integrally formed and made of a metal material with high heat-conductivity. However, the heat-dissipation fin 272 of the present embodiment is not limited to be disposed on the first bracket 232. In other words, the heat-dissipation fin 272 can be disposed either on a second bracket 234 or on both the first bracket 232 and the second bracket 234.

FIG. 3G is a schematic view of a light integration rod module according to a third embodiment of the present invention. Referring to FIG. 3G, the present embodiment is similar to that in FIG. 3F except a heat-dissipation fin 270 of the present embodiment is disposed on the holder 210 and exposed outside the bracket set 230. In other words, the present embodiment has the heat-dissipation fins 270 and 272 be disposed on the holder 210 and the bracket set 230, respectively.

In this way, the heat produced by the light integration rod module 200 is able to be quickly conducted to the heat-dissipation fin 270 via the holder 210 or the heat-dissipation fin 272 on the bracket set 230, and further to the ambient. Therefore the light integration rod module 200 of the present invention has a better heat-dissipation effect. The layout with the heat-dissipation fin 270 disposed on the holder 210 is described as exemplary hereinafter.

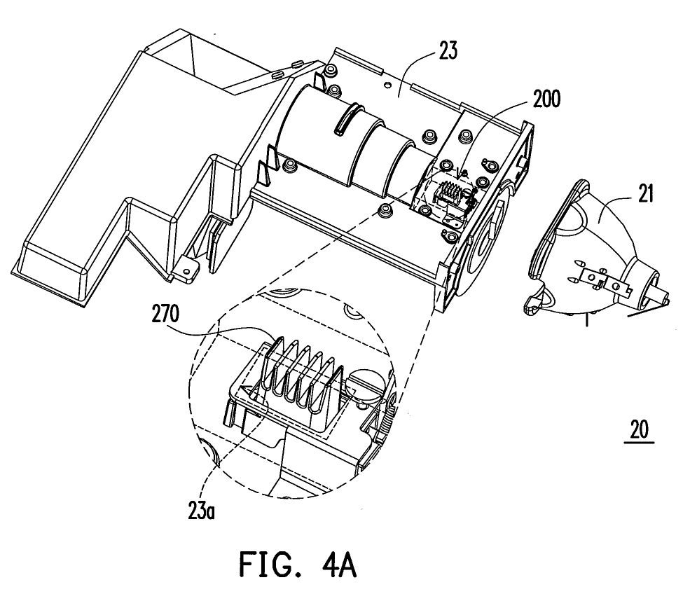

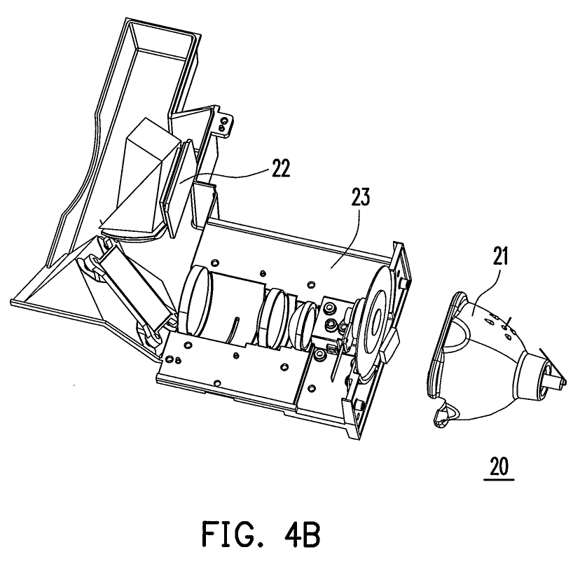

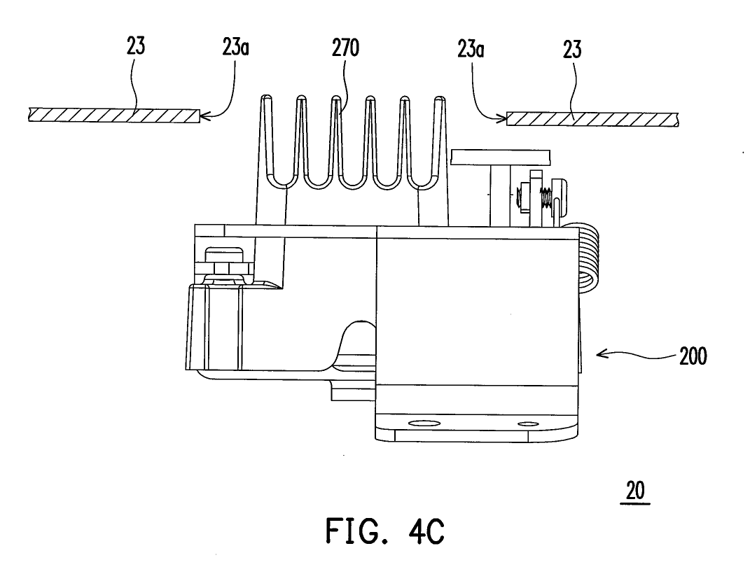

Referring to FIGS. 4A˜4C, the optical engine 20 of the present invention includes a light source 21, an above-described light integration rod module 200 (as shown in FIGS. 3A˜3C), a light valve 22 and a case 23. The light source 21 is for producing a light beam (not shown), the light integration rod module 200 is suitable for homogenizing the light beam, and the light valve 22 is disposed on the optical path of the light beam which passed through the light integration rod module 200 and suitable for converting the light beam into an image. Besides, the light integration rod module 200 and the light valve 22 are disposed in the case 23.

In the embodiment, to advance the heat-dissipation effect of the optical engine 20, the case 23 has an opening 23a, and the heat-dissipation fin 270 is exposed outside the case through the opening 23a. Once the heat produced by the light integration rod 220 is conducted to the heat-dissipation fin 270, the air convection takes away the heat. In this way, the heat is not accumulated inside the case 23, which makes the optical engine 20 maintain a stable quality. Furthermore, since the components inside the optical engine 20 do not need to endure a high temperature which may lead to damage, thus, the optical engine 20 can have a longer lifetime. In a similar way, the heat-dissipation fin 272 of the present invention is also suitable for the optical engine 20.

In a reflective optical engine of the present invention, the light valve 22 can be, but not limited to, a digital micro mirror device (DMD). For example, the light valve 22 can be a liquid crystal on silicon (LCOS), while in a transmissive optical engine, the light valve 22 can be a transmissive LCD panel. In addition, for a precise incidence into the light valve 22 of the light beam, anyone skilled in the art can use optical components, for example, mirrors or total internal reflection prisms (TIR prisms) to adjust the optical path of the light beam, or make some appropriate modifications according to the above-described spirit of the present invention, all of which belong to the scope or spirit of the invention.

However, the methods to advance the heat-dissipation effect of the present invention is not limited to exposing the heat-dissipation fins 270 and 272 outside the case 23. In the following, another yet embodiment is described.

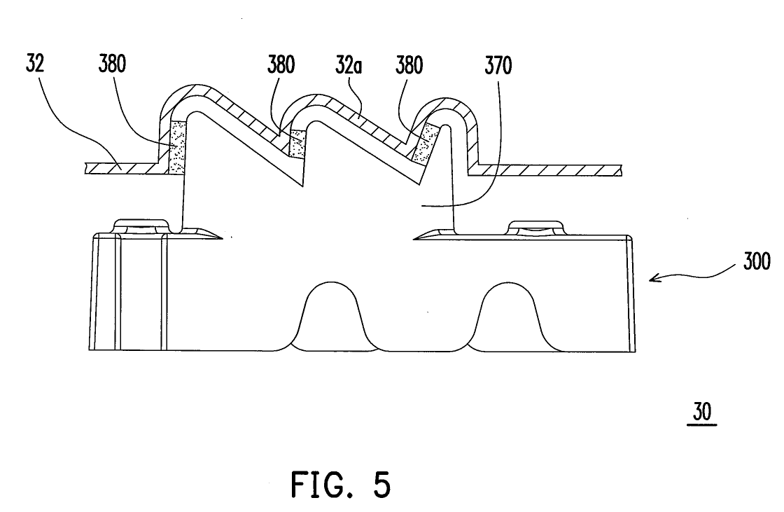

Referring to FIG. 5, the optical engine 30 of the present embodiment is similar to the optical engine 20 in FIG. 4C. To avoid confusion, all components with the same names in FIG. 5 and FIG. 4C are marked with different symbols but have the same functions. The optical engine 30 of the present embodiment includes a light source (not shown), a light integration rod module 300 (similar to the light integration rod module 200 in FIGS. 3A˜3C), a light valve (not shown) and a case 32. The light integration rod module 300 has a heat-dissipation fin 370 and the case 32 has a heat-dissipation portion 32a with a shape matching the associated heat-dissipation fin 370.

Once the heat produced by the light integration rod module 300 is conducted to the heat-dissipation fin 370, since the heat-dissipation portion 32a is adjacent to the heat-dissipation fin 370, the heat-dissipation fin 370 is able to transfer the heat to the heat-dissipation portion 32a by means of conduction or radiation. Then, the heat on the case 32 is took away by means of air convection, which advances the heat-dissipation effect of the optical engine 30.

To further advance the heat-dissipation effect of the optical engine 30, the light integration rod module 300 can further include a heat-conductive material 380, which is disposed between the heat-dissipation fin 370 and the heat-dissipation portion 32a to improve the efficiency of transferring heat from the heat-dissipation fin 370 to the heat-dissipation portion 32a. Note that in both the embodiments of the optical engine 20 of FIG. 4C and the optical engine 30 of FIG. 5, the constitution of the adjusting units of the light integration rod modules in the optical engine 20 and the optical engine 30 are not limited in the present invention.

In summary, the light integration rod module and the optical engine of the present invention have at least the following advantages:

1. In comparison with the conventional light integration rod module, the adjusting unit of the present invention includes a first adjusting element, a second adjusting element and an elastic element only. By using these three elements, the position where the light beam gets incident into the light integration rod (i.e. the relative positions of the holder and the bracket set) can be adjusted, which contributes to lower the component number and the cost and further to reduce the working hours for assembling.

2. The holder and the bracket set have simpler structures, which contributes to save the fabrication costs of the holder and the bracket set.

3. In an embodiment, the heat-dissipation fin of the present invention is disposed on the holder and exposed outside the case, which is able to effectively take away the heat of the light integration rod and assure the optical engine to maintain a stable quality during operating.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light integration rod module, for an optical engine to homogenize a light beam provided by a light source of the optical engine, the light integration rod module comprising:
a holder, forming an accommodation space;
a light integration rod, disposed in the accommodation space;
a bracket set, supporting the holder and the light integration rod;
an adjusting unit, adjusting the relative positions of the holder and the bracket set, the adjusting unit comprising:
a first adjusting element, disposed through the bracket set and pushing the holder to adjust the relative positions of the holder and the bracket set along a first axis direction;
a second adjusting element, disposed through the bracket set for pushing the holder to adjust the relative positions of the holder and the bracket set along a second axis direction; and
an elastic element, both ends of the elastic element being respectively connected to the bracket set and the holder, the elastic element providing the holder with a pull force towards the bracket set, and the direction of the pull force being different from the first axis direction and the second axis direction.

2. The light integration rod module as recited in claim 1, wherein the pull force is composed by a first pull force and a second pull force, a direction of the first pull force is parallel to the first axis direction, a direction of the second pull force is parallel to the second axis direction, the first adjusting element is providing the holder with a first push force away from the bracket set, a direction of the first push force is opposite to the direction of the first pull force, the first push force counterbalances with the first pull force, the second adjusting element is providing the holder with a second push force away from the bracket set, a direction of the second push force is opposite to the direction of the second pull force, the second push force counterbalances with the second pull force, and the first axis direction is perpendicular to the second axis direction.

3. The light integration rod module as recited in claim 1, wherein the light integration rod module further comprises a first connection element and a second connection element, the bracket set comprises a first bracket and a second bracket, the first connection element is connecting the first bracket to the second bracket, the second connection element is connecting the second bracket to the holder, the first adjusting element is disposed through the first bracket, the second adjusting element is disposed through the second bracket, both ends of the elastic element respectively hitch the first bracket and the holder, the first connection element restricts on the relative positions of the first bracket and the second bracket along the second axis direction, the second connection element restricts on the relative positions of the second bracket and the holder along the first axis direction, and both the first connection element and the second connection element are positioning screws.

4. The light integration rod module as recited in claim 1, wherein the first adjusting element and the second adjusting element are adjusting screws and the elastic element is a spring or a wire spring.

5. The light integration rod module as recited in claim 1, further comprising a heat-dissipation fin disposed on the holder and exposed outside the bracket set.

6. An optical engine, comprising:
a light source, providing a light beam;
a light integration rod module, disposed on the optical path of the light beam, the light integration rod module comprising:
a holder, forming an accommodation space;
a light integration rod, disposed in the accommodation space, and the light beam getting incident into the light integration rod;
a bracket set, supporting the holder and the light integration rod;
an adjusting unit, adjusting the relative positions of the holder and the bracket set, the adjusting unit comprising:
a first adjusting element, disposed through the bracket set and pushing the holder to adjust the relative positions of the holder and the bracket set along a first axis direction;
a second adjusting element, disposed through the bracket set and pushing the holder to adjust the relative positions of the holder and the bracket set along a second axis direction;
an elastic element, both ends of the elastic element being respectively connected to the bracket set and the holder, the elastic element providing the holder with a pull force towards the bracket set, and the direction of the pull force being different from the first axis direction and the second axis direction;
a light valve, disposed on the optical path of the light beam which passed through the light integration rod module; and
a case, the light integration rod module and the light valve being disposed in the case.

7. The optical engine as recited in claim 6, wherein the light integration rod module comprises a heat-dissipation fin disposed on the holder and exposed outside the bracket set.

8. The optical engine as recited in claim 7, wherein the case has an opening and the heat-dissipation fin is exposed outside the case through the opening.

9. The optical engine as recited in claim 7, wherein the case has a heat-dissipation portion with a shape matching the heat-dissipation fin and the heat-dissipation fin is adjacent to the heat-dissipation portion.

10. The optical engine as recited in claim 9, wherein the light integration rod module further comprises a heat-conductive material disposed between the heat-dissipation fin and the heat-dissipation portion.

11. The optical engine as recited in claim 6, wherein the light integration rod module comprises a heat-dissipation fin disposed on the bracket set.

12. The optical engine as recited in claim 6, wherein the pull force is composed by a first pull force and a second pull force, a direction of the first pull force is parallel to the first axis direction, a direction of the second pull force is parallel to the second axis direction, the first adjusting element is providing the holder with a first push force away from the bracket set, a direction of the first push force is opposite to the direction of the first pull force, the first push force counterbalances with the first pull force, the second adjusting element is providing the holder with a second push force away from the bracket set, a direction of the second push force is opposite to the direction of the second pull force, the second push force counterbalances with the second pull force, and the first axis direction is perpendicular to the second axis direction.

13. The optical engine as recited in claim 6, wherein the light integration rod module further comprises a first connection element and a second connection element, the bracket set comprises a first bracket and a second bracket, the first connection element is connecting the first bracket to the second bracket, the second connection element is connecting the second bracket to the holder, the first adjusting element is disposed through the first bracket, the second adjusting element is disposed through the second bracket, both ends of the elastic element are respectively connected to the first bracket and the holder, the first connection element restricts on the relative position between the first bracket and the second bracket along the second axis direction, the second connection element restricts on the relative position of the second bracket and the holder along the first axis direction and both the first connection element and the second connection element are positioning screws.

14. The optical engine as recited in claim 6, wherein the first adjusting element and the second adjusting element are adjusting screws, and the elastic element is a spring or a wire spring.

15. An optical engine, comprising:
a light source, providing a light beam;
a light integration rod module, disposed on the optical path of the light beam, the light integration rod module comprising:
a holder, forming an accommodation space;
a light integration rod, disposed in the accommodation space, and the light beam getting incident into the light integration rod;
a bracket set, supporting the holder and the light integration rod;
a heat-dissipation fin, disposed on the holder or on the bracket set and exposed outside the bracket set;
an adjusting unit, adjusting the relative positions of the holder and the bracket set;
a light valve, disposed on the optical path of the light beam which passed through the light integration rod module; and
a case, the light integration rod module and the light valve being disposed in the case, the case having a heat-dissipation portion with a shape matching the heat-dissipation fin and the heat-dissipation fin being adjacent to the heat-dissipation portion.

16. The optical engine as recited in claim 15, wherein the light integration rod module further comprises a heat-conductive material disposed between the heat-dissipation fin and the heat-dissipation portion.
